(19) United States
(12) Patent Application Publication
(10) Pub. No.: US 2026/0009426 A1
(43) Pub. Date: Jan. 8, 2026

(54) CONSTANT CROSS-SECTION BEARING

(71) Applicant: AKTIEBOLAGET SKF, Goteborg (SE)

(72) Inventors: Weihua QIAN, Shanghai (CN); Hongyan WANG, Shanghai (CN); Meng ZHANG, Shanghai (CN)

(21) Appl. No.: 19/252,183

(22) Filed: Jun. 27, 2025

(30) Foreign Application Priority Data
Jul. 4, 2024 (CN) 202410892316.X

(51) Int. Cl. F16C 33/58; F16C 19/08

(52) U.S. Cl. CPC F16C 33/583; F16C 19/08

(57) ABSTRACT

A constant cross-section bearing has an outer race and an inner race, one of which is a target ring including first and second ring portions disposed axially opposite each other and third and fourth ring portions disposed axially opposite each other. The third ring portion is disposed outside and surrounds the first ring portion and the fourth ring portion is disposed outside and surrounds the second ring portion. A first damper is disposed between the first and third ring portions and a second damper is disposed between the second and fourth ring portions. The target ring is formed as a nested structure with a damper so that the stiffness level of the bearing is adjusted to a suitable level to absorb expansion, deformation, vibration, etc., so as to effectively improve the rotational torque and noise level of the bearing.

### CROSS-REFERENCE

This application claims priority to Chinese patent application no. 202410892316.X filed on Jul. 4, 2024, the contents of which are fully incorporated herein by reference.

### BACKGROUND OF THE INVENTION

The present invention relates to bearings, and more particularly to bearings having a constant cross-section.

A constant-section bearing, also referred to as a constant cross-section thin-walled bearing, is a type of bearing having a substantially constant cross-sectional dimension, which includes, for example, four-point contact ball bearings, angular contact ball bearing pairs, and wire raceway ball bearings. Constant cross-section bearings are widely used for rotating bodies with large diameters, such as medical CT scanners and safety scanners. Constant cross-section bearings have advantages of light weight, thin wall, high load capacity and smooth operation.

However, when the constant cross-section bearing rotates, due to the different heat dissipation areas of the inner and outer rings, the temperature equilibrium points of the inner and outer rings are also different. Generally speaking, temperature of the inner ring is higher than that of the outer ring. This temperature inconsistency will cause a temperature gradient in the bearing. When the inner and outer rings are made of the same material, the temperature gradient will cause different thermal expansion of the inner and outer rings and will change the play between the inner and outer rings. If the play increases, noise of the bearing will also increase, and if the play decreases, the internal stress of the bearing will increase, thus increasing the friction torque.

Similarly, when the inner and outer rings are made of different materials, if there is a large temperature difference between the place where the bearing is used and the place where the bearing is manufactured, although there is no temperature gradient as a whole of the bearing, there will also be a change in play due to different thermal expansion coefficients of different materials, thereby causing the above-mentioned problems of increased noise or increased friction torque.

Attempts have been made to solve these problems by carefully adjusting the play between the inner and outer rings and the fit between the bearing housing and the inner and outer rings, but this adjustment is expensive and cannot completely eliminate the above-mentioned problems. Another solution is to use a wire race, but its inherent play continues to cause problems like noise etc., and even if a damper made of rubber is added, it will not solve the above problems.

### SUMMARY OF THE INVENTION

In view of the above-mentioned problems and requirements, the present disclosure proposes a new technical solution, which solves the above-mentioned problems by adopting the following technical features and brings other technical effects.

The present disclosure provides a constant cross-section bearing in which at least one of an outer race and an inner race is set as a target ring, which comprises: a first ring portion and a second ring portion disposed opposite to each other in an axial direction; a third ring portion and a fourth ring portion disposed opposite to each other in the axial direction. The third ring portion is disposed outside and surrounding the first ring portion, and the fourth ring portion is disposed outside and surrounding the second ring portion. A first damper is disposed between the first ring portion and the third ring portion, and a second damper is disposed between the second ring portion and the fourth ring portion.

In the constant cross-section bearing structure of the invention, the target ring (outer ring/inner ring) is configured as a nested structure, and a damper is added in the structure, so that the stiffness level of the whole bearing is adjusted to a suitable level to absorb expansion, deformation, vibration, etc., so as to effectively improve the rotational torque and noise level of the bearing.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 shows a perspective view of a constant cross-section bearing according to a preferable embodiment of the present disclosure;

FIG. 2 shows a cross-sectional view of the constant cross-section bearing shown in FIG. 1;

FIG. 3 shows a diagram of a schematic equivalent system consisted of a damper and an adjacent outer ring portion and a graph of the relationship between stiffness and load of the system;

FIG. 4 shows a schematic structural diagram of the third ring portion and the first damper shown in FIG. 1;

FIG. 5 shows an enlarged view of portion A of FIG. 4;

FIG. 6 shows a schematic diagram of an assembly process of the third ring portion, the first ring portion, and the first damper shown in FIG. 4;

FIG. 7 is a schematic view of a state in which the third ring portion, the first ring portion, and the first damper are completely assembled;

FIG. 8 is a perspective view of a damper section according to a preferable embodiment of the present disclosure.

### DETAILED DESCRIPTION OF THE INVENTION

In order to make the purpose, technical solution and advantages of the technical solution of the present disclosure clearer, the technical solution of the embodiment of the present disclosure will be described clearly and completely in the following with the attached drawings of specific embodiments of the present disclosure. Like reference numerals in the drawings represent like components. It should be noted that a described embodiment is a part of the embodiments of the present disclosure, not the whole embodiments. Based on the described embodiments of the present disclosure, all other embodiments obtained by those skilled in the field without creative labor fall into the scope of protection of the present disclosure.

In comparison with the embodiments shown in the attached drawings, feasible embodiments within the protection scope of the present disclosure may have fewer components, other components not shown in the attached drawings, different components, components arranged differently or components connected differently, etc. Furthermore, two or more components in the drawings may be implemented in a single component, or a single component shown in the drawings may be implemented as a plurality of separate components.

Unless otherwise defined, technical terms or scientific terms used herein shall have their ordinary meanings as understood by those skilled in the field to which this disclosure belongs. The terms “first”, “second” and similar terms used in the specification and claims of the patent application of this disclosure do not indicate any order, quantity or importance, but are only used to distinguish different components. When the number of components is not specified, the number of components can be one or more. Similarly, terms such as “a/an”, “the” and “said” do not necessarily mean quantity limitation. Similar terms such as “including” or “comprising” mean that the elements or objects appearing before the terms cover the elements or objects listed after the terms and their equivalents, without excluding other elements or objects. Similar terms such as “installation”, “setting”, “connection” or “matching” are not limited to physical or mechanical installation, setting and connection, but can include electrical installation, setting and connection, whether directly or indirectly. “Up”, “down”, “left” and “right” are only used to indicate the relative orientation relationship when the equipment is used or the orientation relationship shown in the attached drawings. When the absolute position of the described object changes, the relative orientation relationship may also change accordingly.

For convenience of illustration, a direction of the rotation axis of the bearing is referred to herein as an axial direction, and a direction perpendicular to the axial direction is referred to as a radial direction. The term “inner/inward” refers to the direction towards the inside of the bearing, and conversely the term “outer/outward” refers to the direction towards the outside of the bearing.

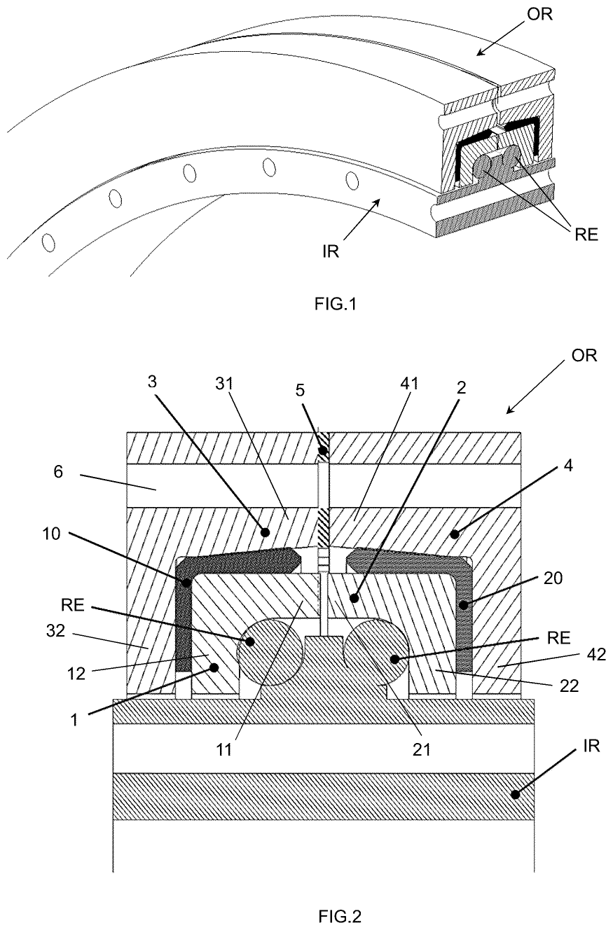

Preferable embodiments according to the present disclosure are described below with reference to the accompanying drawings. As shown in FIG. 1, a constant cross-section bearing according to a preferable embodiment of the present disclosure includes an outer race OR, an inner race IR, and a rolling element RE disposed between the outer race OR and the inner race IR. Although the embodiments below and in the accompanying drawings describe the present disclosure by taking the outer ring OR as an example, it is to be understood that the concept of the present disclosure can be applied to the inner ring IR, that is, at least one of the outer ring OR and the inner ring IR can be deemed as a target ring and applied to the target collar. After understanding the principles of the present disclosure after reading the description of the outer ring OR hereinafter, a similar structure may be provided for the inner ring IR, which can be basically understood as a “mirror image” of the outer ring OR structure. Therefore, in order to avoid redundant description, the description of the inner ring IR will not be repeated.

Referring to FIGS. 1 and 2, the outer ring OR includes a first ring portion 1 and a second ring portion 2 disposed opposite to each other in the axial direction; and a third ring portion 3 and a fourth ring portion 4 disposed opposite to each other in the axial direction. The third ring portion 3 is disposed outside the first ring portion 1 (i.e. on the side away from the rolling element) and surrounds the first ring portion 1, and the fourth ring portion 4 is disposed outside and surrounds the second ring portion 2. Further, a first damper 10 is disposed between the first ring portion 1 and the third ring portion 3, and a second damper 20 is disposed between the second ring portion 2 and the fourth ring portion 4.

It is to be understood that the term “disposed opposite to each other” as used herein means that the relevant components or portions are disposed facing each other and aligned with each other substantially on the same circumferential surface.

It can be seen that the present disclosure specifically proposes that the outer ring is divided into “nested” portions and dampers are arranged between these portions, so that when the whole bearing is regarded as a system, this arrangement not only ensures that the system has sufficient stiffness, but also improves the stiffness matrix of the bearing system, that is, also takes into account the compliance, so that the deformation and stress generated in the whole structure can be effectively alleviated or even absorbed in the case of preload force change, temperature gradient between the inner and outer ring, or significant temperature difference between the factory environment and the practical application environment, thereby improving the noise and friction torque of the bearing. Moreover, the vibration caused by the unbalance of the rolling elements can also be absorbed by the relatively soft damper, further reducing the rotational noise level of the entire bearing.

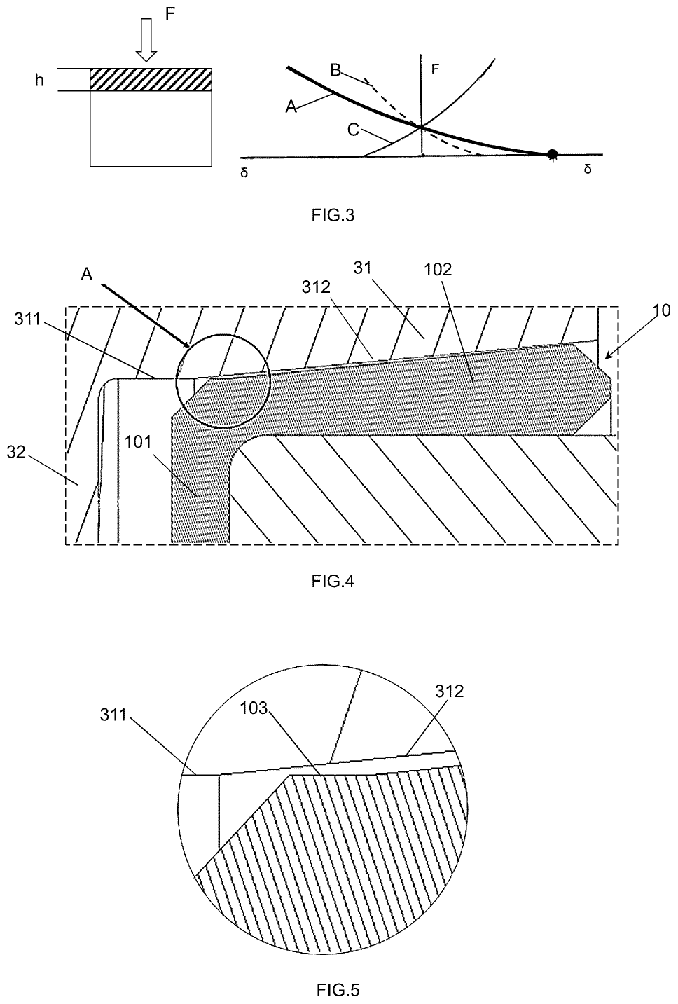

Referring specifically to FIG. 3, there is shown a schematic equivalent system consisted of the damper and adjacent outer ring portions and a graph of the relationship between stiffness and load of the system. In the graph, abscissa δ is the play interference between the outer ring and the inner ring of the bearing, with positive play to the right and negative play to the left. In addition, δ may be equivalent to the overall deformation amount of the damper after the load is applied (the deformation amount of other components is negligible). The ordinate F is the load transmitted to the rolling element. Thus, δ satisfies: δ=Fh/E/A, where h is thickness of the damper, E is the damper elastic modulus, and A is cross-section area of the damper. It can be seen that δ also represents the stiffness of the equivalent system.

Referring further to the graph, curve A is a load-stiffness curve of the bearing system to which the present disclosure is applied, and curves B and C are load-stiffness curves of the bearing system to which the structure of the present disclosure is not applied, measured from both sides of the rolling element, respectively. It can be seen that curve A is more gentle and has a wider range than curves B and C, which means that the effect of bearing play changes on the load F becomes less significant after applying the present disclosure. In other words, after the application of the present disclosure, the flexibility of the entire system increases, the stiffness decreases, and the sensitivity of the entire system to noise and torque caused by the foregoing causes decreases. For example, in the case the inner and outer rings are manufactured from the same material, when there is a temperature gradient or materials with different coefficients of thermal expansion are used, the reduction in play between the inner and outer rings will cause a significant change in friction torque without the damper being applied, while the reduction in play between the inner and outer rings will cause only a small change in friction torque to the bearing with the damper applied, e.g., the change of friction torques between the two situation is over 90%.

It should be understood that the damper can be made of a variety of materials. For example, for large-diameter bearings on CT scanners and the like, PA12 (polylaurolactam or Nylon 12) can be selected to manufacture the damper. It has been found that this material provides suitable hardness and softness. The damper may have an elastic modulus within a range of 1 Gigapascal and 6 Gigapascals, preferably 3 Gigapascals, and may have a thickness with a value within a range of between 5% and 25%, preferably 15%, of a value of a thickness of the adjacent ring portions. Furthermore, a plastic material such as PEEK, PET, epoxy, PC, PS, PP, polyester, or a suitable rubber material or the like may be selected to manufacture the damper.

Further preferably, the first ring portion I and the second ring portion 2 may have an L-shaped cross-section, and the axially extending wall 11 of the first ring portion 1 and the axially extending wall 21 of the second ring portion 2 are disposed opposite to each other, to form a space between the first ring portion 1 and the second ring portion 2 that accommodates the rolling elements RE.

Further preferably, the third ring portion 3 and the fourth ring portion 4 have an L-shaped cross-section, and the axially extending wall 31 of the third ring portion 3 is opposed to the axially extending wall 41 of the fourth ring portion 4 to form a space between the third ring portion 3 and the fourth ring portion 4 that accommodates the first ring portion 1 and the second ring portion 2.

Further, a washer 5 may be disposed between the axially extending wall 31 of the third ring portion 3 and the axially extending wall 41 of the fourth ring portion 4. The third ring portion 3 and the fourth ring portion 4 may further comprise an axial hole 6 such that the third ring portion 3 and the fourth ring portion 4 are connected together by a fastener (not shown) passing through the axial hole 6. The fastener may be, for example, a bolt such that a fastening force between the third ring portion 3 and the fourth ring portion 4 may be adjusted by rotating the bolt, such that a pre-tightening force or preload of the whole bearing may be adjusted.

FIG. 4 shows a state in which the first ring portion 1, the third ring portion 3 and the first damper 10 are roughly positioned prior to assembly. FIG. 5 is an enlarged view of portion A of FIG. 4.

The first damper 10 is provided as an annular damper sandwiched between the first ring portion 1 and the third ring portion 3 and having an L-shaped cross-section, and the first damper 10 comprises a radially extending wall 101 and an axially extending wall 102 extending from the radially extending wall 101 in a manner with the thickness progressively increasing, preferably the axially extending wall 102 having a conical outer surface.

Further, the axially extending wall 31 of the third ring portion 3 includes a cylindrical surface portion 311 and a conical surface portion 312 connected to the cylindrical surface portion 311. The conical surface portion 312 is configured to be connected to the radially extending wall 32 of the third ring portion 3 and is configured to gradually decrease in thickness from the cylindrical surface portion 311 toward the edge of the axially extending wall 31 of the third ring portion 3. In other words, the cylindrical surface portion 311 is provided at a portion of the axially extending wall 31 of the third ring portion 3 that is connected to the radially extending wall 32, and the small diameter portion of the conical surface portion 312 joins to the cylindrical surface portion 311 and the large diameter portion of the conical surface portion 312 forms an edge of the axially extending wall 31 of the third ring portion 3. Also preferably, at the corner between the radially extending wall 101 and the axially extending wall 102 of the first damper 10, there is a cylindrical surface portion 103 that conforms with the cylindrical surface portion 311 of the third ring portion 3. The above-described shape design of the third ring portion 3 and the first damper 10 can effectively improve accuracy and efficiency for assembling the third ring portion 3 and the first damper 10.

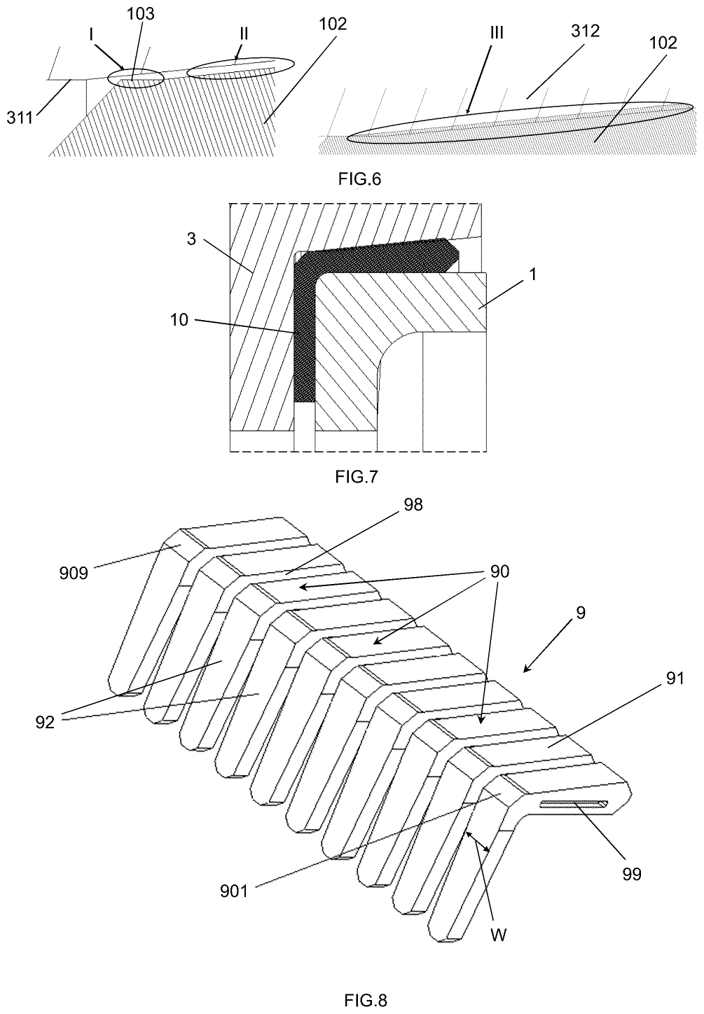

In particular, referring to FIGS. 6 and 7, during assembly, the radially extending wall 32 of the third ring portion 3 needs to be placed flat on the ground to expose the space for receiving the first ring portion 1 and the first damper 10; subsequently, the first damper 10 and the first ring portion 1 form a temporary assembly, which is placed in the axial direction into the third ring portion 3. During this placement process, the cylindrical surface portion 103 of the first damper 10 and the cylindrical surface portion 311 of the third ring portion 3 may cooperate with each other for accurate centering (as shown by the frame 1 in FIG. 6), so that subsequent operation of pressing the assembly into the third ring portion 3 can be accurately and efficiently guided. And in this state, the axially extending wall 102 of the first damper 10 has not yet fully contacted the conical surface portion 312 of the axially extending wall 31 of the third ring portion 3 (as shown by the frame II in FIG. 6). Subsequently, the first damper 10 and the first ring portion 1 are completely pressed into the third ring portion 3 in the axial direction (as shown by the frame III in FIG. 6) by a further press-in operation, and finally the state shown in FIG. 7 is reached. It should be understood that although the frame III of FIG. 6 shows that the conical outer surface of the axially extending wall 102 of the first damper 10 and the conical surface portion 312 of the third ring portion 3 are overlapped, this is only a schematic illustration for the purpose of illustrating the dimensional relationship between the two, and the axially extending wall 102 of the first damper 10 will be squeezed after the press-in operation.

Therefore, with the above-described structure, the preliminary positioning and centering between the cylindrical surface portion 311 of the third ring portion 3 and the cylindrical surface portion 103 of the first damper 10 can avoid the first damper 10 being skewed during the press-in process. Moreover, in the subsequent press-in process, the conical surface portion 312 of the third ring portion 3 and the axially extending wall 102 of the first damper 10 also facilitate the uniform and balanced execution of the press-in operation of the temporary assembly by applying a gradually increasing pressure.

In addition, the axial lengths of the cylindrical surface portion 311 of the third ring portion 3 and the cylindrical surface portion 103 of the first damper 10 can be flexibly selected according to the bearing structure, damper length, and mounting requirements.

As described above, the conical surface portion 312 of the third ring portion 3 and the conical outer surface of the axially extending wall 102 of the first damper 10 need to be set by comprehensively considering factors such as the magnitude of the press-in force for mounting, the direction of the external load during bearing operation, and the spacing of the external mounting holes. Therefore, both of them preferably usually have a taper within a range of ⅕ to 1/20, and the axial angle is within a range of 1° to 6°.

Although not specifically shown, the second damper 20 and the fourth ring portion 4 also have a similar configuration. For example, in a preferable embodiment not shown, the second damper may be configured as an annular damper sandwiched between the second ring portion and the fourth ring portion and having an L-shaped cross-section, and the second damper comprises a radially extending wall and an axially extending wall extending from the radially extending wall in a manner with the thickness progressively increasing. The axially extending wall of the fourth ring portion includes a cylindrical surface portion and a conical surface portion connected to the cylindrical surface portion, the cylindrical surface portion being configured to be connected to the radially extending wall of the fourth ring portion, and the conical surface portion being configured to gradually decrease in thickness from the cylindrical surface portion toward the edge of the axially extending wall of the fourth ring portion. In other words, the cylindrical surface portion is provided at a portion of the axially extending wall of the fourth ring portion connected with the radially extending wall, and the small diameter portion of the conical surface portion joins to the cylindrical surface portion and the large diameter portion of the conical surface portion forms an edge of the axially extending wall of the fourth ring portion. At the corner between the radially extending wall and the axially extending wall of the second damper, there is a cylindrical surface portion that conforms with the cylindrical surface portion of the fourth ring portion.

In addition, the assembly process of the second ring portion 2, the second damper 20, and the fourth ring portion 4 is also substantially similar to the assembly process of the first ring portion 1, the first damper 10, and the third ring portion 3 described above, and as such will not be repeated herein.

It should be understood that although the first damper 10 and the second damper 20 having an L-shaped cross-section are proposed above, in other preferable embodiments not shown, the first and second dampers may have other forms or shapes. For example, the first and second dampers may have a simple annular shape with a substantially rectangular cross-section.

Specifically, the first damper may be configured as an annular damper sandwiched between the axially extending wall 11 of the first ring portion I and the axially extending wall 31 of the third ring portion 3, or the first damper may be configured as an annular damper sandwiched between the radially extending wall 12 of the first ring portion 1 and the radially extending wall 32 of the third ring portion 3.

Similarly, the second damper may be configured as an annular damper sandwiched between the axially extending wall 21 of the second ring portion 2 and the axially extending wall 41 of the fourth ring portion 4, or the second damper may be configured as an annular damper sandwiched between the radially extending wall 22 of the second ring portion 2 and the radially extending wall 42 of the fourth ring portion 4.

With continued reference to FIG. 8, the present disclosure also proposes a preferable configuration of the damper to accommodate large diameter bearings on CT scanners.

Specifically, in a preferable embodiment shown in FIG. 8, the first damper 10 and the second damper 20 each may be formed by a plurality of damper sections 9 spliced together (FIG. 8 shows one of the damper sections 9), and each damper section 9 may include a plurality of segments 90 connected and spaced apart from each other, such as spaced apart by grooves 98. Further preferably, the axially extending walls 91 of adjacent segments 90 are connected with each other by a connecting tab having a thickness less than a thickness of the axially extending wall 91. Although not shown, those skilled in the art will appreciate that the connecting tab is present in the groove 98. Preferably, the width of the groove 98 may have a value of between 1/10 to ⅓ of a value of a width of the segment 90.

With this structure, it is possible to flexibly select the length of each damper section 9 depending on the circumference, load requirements of the bearing, etc. And during assembly, the damper section 9 may be spliced and bent into an annular shape to mount around the corresponding ring portion. The presence of the grooves 98 prevents interference between the segments 90 when the damper section 9 is bent, thereby causing no stress and deformation inside the damper section 9.

Further preferably, unlike the axially extending walls 91, the radially extending walls 92 of adjacent segments 90 are not connected to each other, and the radially extending wall 92 of each segment 90 has a width W that gradually decreases from its root towards its end. Specifically, as shown in FIG. 8, the root of the radially extending wall 92 is connected to the axially extending wall 91 and ends at a free end, and the radially extending wall 92 is formed to be wide at the top and narrow at the bottom so that when the damper section 9 is bent, the ends of the radially extending walls 92 of the adjacent segments 90 will gather with each other but do not interfere with each other, to accommodate different bearing sizes and facilitate the adjustment of the axial stiffness of the bearing.

Furthermore, in addition to providing convenience during assembly, the presence of the groove 98 in the damper section 9 and the radially extending wall 92, which is wide at the top and narrow at the bottom, also provides a space for absorbing thermal expansion and deformation in the case of thermal expansion or extrusion deformation of the damper and in the case of circumferential deformation of the damper caused by rotation of the bearing, thereby avoiding adverse effects on the operation of the bearing.

Preferably, in order to accommodate the splicing between adjacent damper sections 9 as previously described, the invention further proposes that the starting segment 901 of the damper section 9 may include a groove 99 disposed in a side of the axially extending wall of the starting segment 901, and that the end segment 909 may include a projection disposed on a side of the axially extending wall of the end segment 909, such that the corresponding segments 90 of adjacent damper section 9 are connected together by a plug-in-fitting of the corresponding projection and groove 99.

Having understood the above principles of the present disclosure, those skilled in the art can provide other splicing structures, and still fall within the scope of the present disclosure. Furthermore, it should also be understood that the damper sections 9 may also be spliced together by simply abutting against each other without a specific plug-in-fitting structure where assembly requirements are not high.

The invention proposes a constant cross-section bearing structure, in which a target ring (outer ring/inner ring) is configured as a nested structure, and a damper is added in the structure, so that the stiffness level of the whole bearing is adjusted to a suitable level to absorb expansion, deformation, vibration, etc., so as to effectively improve the rotational torque and noise level of the bearing.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A constant cross-section bearing comprising:
an outer race;
an inner race; and
at least one rolling element disposed between the outer race and the inner race;
wherein at least one of the outer race and the inner race is a target ring including a first ring portion and a second ring portion, the first and second ring portions being disposed opposite to each other in an axial direction, and a third ring portion and a fourth ring portion, the third and fourth ring portions being disposed opposite to each other in the axial direction;
wherein the third ring portion is disposed outside and around the first ring portion and the fourth ring portion is disposed outside and around the second ring portion; and
wherein a first damper is disposed between the first ring portion and the third ring portion and a second damper is disposed between the second ring portion and the fourth ring portion.

2. The constant cross-section bearing according to claim 1, wherein each one of the third ring portion and the fourth ring portion has an L-shaped cross-section with an axially extending wall, the axially extending wall of the third ring portion opposing the axially extending wall of the fourth ring portion so as to form a space between the third ring portion and the fourth ring portion for receiving the first ring portion and the second ring portion.

3. The constant cross-section bearing according to claim 2, wherein the first ring portion and the second ring portion each have an L-shaped cross-section with an axially extending wall, the axially extending wall of the first ring portion being disposed opposite to the axially extending wall of the second ring portion so as to form a space between the first ring portion and the second ring portion for accommodating the rolling element.

4. The constant cross-section bearing according to claim 2, wherein,
the first damper is configured as an annular damper sandwiched between the axially extending wall of the first ring portion and the axially extending wall of the third ring portion, or the first damper is configured as an annular damper sandwiched between a radially extending wall of the first ring portion and a radially extending wall of the third ring portion; and/or
the second damper is configured as an annular damper sandwiched between the axially extending wall of the second ring portion and the axially extending wall of the fourth ring portion, or the second damper is configured as an annular damper sandwiched between a radially extending wall of the second ring portion and a radially extending wall of the fourth ring portion.

5. The constant cross-section bearing according to claim 2, wherein,
the first damper is configured as an annular damper sandwiched between the first ring portion and the third ring portion and having an L-shaped cross-section, the first damper including a radially extending wall and an axially extending wall extending from the radially extending wall with a progressively increasing thickness;
the axially extending wall of the third ring portion has a cylindrical surface portion and a conical surface portion connected to the cylindrical surface portion, the cylindrical surface portion being connected to the radially extending wall of the third ring portion, and the conical surface portion having a thickness which gradually decreases in a direction from the cylindrical surface portion and toward an edge of the axially extending wall of the third ring portion;
a cylindrical surface portion of the first damper is formed at the corner between the radially extending wall of the first damper and the axially extending wall of the first damper, the cylindrical surface portion conforming with the cylindrical surface portion of the third ring portion; and
the axially extending wall of the first damper has a conical outer surface, the conical surface portion of the axially extending wall of the third ring portion and the conical outer surface of the axially extending wall of the first damper have a taper within a range of ⅕ to 1/20 and/or define an axial angle with a value within a range 1° to 6°.

6. The constant cross-section bearing according to claim 5, wherein the first damper is formed of a plurality of damper sections, the plurality of damper sections being spliced together and each damper section including a plurality of segments connected to each other and spaced apart by a groove.

7. The constant cross-section bearing according to claim 6, wherein at least one of:
a width of the groove has a value within a range of 1/10 to ⅓ of a value of a width of each segment;
each segment has an axially extending wall and the axially extending walls of adjacent segments being connected with each other by a connecting tab having a thickness less than the thickness of the axially extending wall;
each segment has a radially extending wall and the radially extending walls of adjacent segments are unconnected, the radially extending wall of each segment has a width that gradually decreases from a root of the radially extending wall toward an end of the radially extending wall.

8. The constant cross-section bearing according to claim 6, wherein an initial segment of each damper section includes an axially extending wall with a groove formed in a side of the axially extending wall and an end segment includes an axially extending wall with a projection disposed on a side of the axially extending wall such that an initial segment of each damper section is connected with an end segment of an adjacent damper section by a plug-in-fitting of the corresponding projection and the groove.

9. The constant cross-section bearing according to claim 2, wherein,
the second damper is configured as an annular damper sandwiched between the second ring portion and the fourth ring portion and has an L-shaped cross-section, the second damper including a radially extending wall and an axially extending wall extending from the radially extending wall with a progressively increasing thickness;
the axially extending wall of the fourth ring portion includes a cylindrical surface portion and a conical surface portion connected to the cylindrical surface portion, the cylindrical surface portion being connected to the radially extending wall of the fourth ring portion, and the conical surface portion having a thickness which gradually decreases in a direction from the cylindrical surface portion toward an edge of the axially extending wall of the fourth ring portion;
the second damper has a cylindrical surface portion at a corner between the radially extending wall and the axially extending wall coinciding with the cylindrical surface portion of the fourth ring portion.

10. The constant cross-section bearing according to claim 9, wherein the second damper is formed by a plurality of damper sections, the plurality of damper sections being spliced together and each damper section including a plurality of segments connected to each other and spaced apart by a groove.

11. The constant cross-section bearing according to claim 10, wherein at least one of:
a width of the groove has a value within a range of 1/10 to ⅓ of a value of a width of each segment;
each segment has an axially extending wall and the axially extending walls of adjacent segments being connected with each other by a connecting tab having a thickness less than the thickness of the axially extending wall;
each segment has a radially extending wall and the radially extending walls of adjacent segments are unconnected, the radially extending wall of each segment has a width that gradually decreases from a root of the radially extending wall toward an end of the radially extending wall.

12. The constant cross-section bearing according to claim 10, wherein an initial segment of each damper section includes an axially extending wall with a groove formed in a side of the axially extending wall and an end segment includes an axially extending wall with a projection disposed on a side of the axially extending wall such that an initial segment of each damper section is connected with an end segment of an adjacent damper section by a plug-in-fitting of the corresponding projection and the groove.

13. The constant cross-section bearing according to claim 1, wherein the third ring portion has an axially extending wall, the fourth ring portion has an axially extending wall and a washer is disposed between the axially extending wall of the third ring portion and the axially extending wall of the fourth ring portion.

14. The constant cross-section bearing according to claim 1, wherein the third ring portion has an axial bore, the fourth ring portion has an axial bore and the third ring portion and the fourth ring portion are connected together by a fastener passing through the axial bore of the third ring portion and the fourth ring portion.

15. The constant cross-section bearing according to claim 1, wherein the first damper and/or the second damper are made of polylaurolactam.

16. The constant cross-section bearing according to claim 1, wherein the first damper and/or the second damper have an elastic modulus within a range of 1 Gigapascal and 6 Gigapascals.

17. The constant cross-section bearing according to claim 1, wherein at least one of:
a thickness of the first damper has a value within a range of 5% to 25% of a value of a thickness of the first ring portion or of a value of a thickness of the third ring portion; and
a thickness of the second damper has a value within a range of 5% to 25% of a value of a thickness of the second ring portion or of a thickness of the fourth ring portion.
